(19) United States
(12) Patent Application Publication
(10) Pub. No.: US 2008/0084980 A1
(43) Pub. Date: Apr. 10, 2008

(54) System and method of call delivery using an originator-initiated direct-to-call forwarding indicator

(75) Inventors: Cynthia Florkey, Chicago, IL (US); Ruth Schaefer Gayde, Naperville, IL (US); John Richard Rosenberg, Elmhurst, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/524,785

(22) Filed: Sep. 21, 2006

(51) Int. Cl. H04M 3/42

(52) U.S. Cl. 379/201.01

(57) ABSTRACT

A system and method of call delivery from an Originating End to a Terminating End in a telecommunications network is provided in which the Calling Party can direct the call to be forwarded directly to the Called Party's Call Forwarding Destination. An Originator Initiated Direct To Call Forwarding Destination indicator is associated with the call and sent from the Originating End of the telecommunications network to the Terminating End for notifying the Terminating End that the call is to be sent directly to the Called Party's Call Forwarding Destination.

### BACKGROUND OF THE INVENTION

This invention relates to a system and method of call delivery enabling a Calling Party to direct a call to a Called Party's Call Forwarding Destination. While the invention is particularly directed to the art of telecommunications networks, and will be thus described with specific reference thereto, it will be appreciated that the invention may have usefulness in other fields and applications.

By way of background, Call Forwarding enables a call, made by a Calling Party to a particular Called Party Directory Number, to be routed to a different destination referred to as a call forwarding destination. The call forwarding destination is typically defined by a different Directory Number, known as a Forward-to Directory Number. In Internet Protocol (IP) based communications systems, such as for example Session Initiation Protocol (SIP) systems, the call forwarding destination can be defined by a different Uniform Resource Locator (URL). Existing Attendant and Call Center applications provide the capability for the Call-taker, also known as the Attendant, on the Terminating End of the network to transfer an incoming call to the Voice Mail system of a Called Party for whom the Attendant is providing coverage. The Attendant receives the incoming call and processes it according to a predefined routine to determine the ultimate destination, typically defined by a Directory Number, to which to route the call. The Attendant may determine that the Called Party's destination, or line, as defined by the Directory Number dialed by the Calling Party, is busy or unanswered. In this case, the Attendant then routes the call to an alternate destination, usually defined by a different Directory Number. The Attendant may even alert the Calling Party that the Called Party's line is busy and prompt the Calling Party to ask if they want the call to be sent to the Called Party's Voice Mail.

These scenarios, however, depend upon a “coverage” relationship between the Attendant and the Called Party, which allows the transfer feature provided by the Attendant to have access to the Called Party's Voice Mail Directory Number. This coverage relationship may even require the Attendant and the Called Party to be served by the same switch.

Further, the Attendant is not provided with the Calling Party's intention to have the call forwarded directly to the Called Party's Voice Mail without having to first request this information from the Calling Party.

Existing services provided by the telecommunications network can detect when a Called Party destination is busy or does not answer after a predetermined time, and interrupt the call being set up in order to provide an announcement and an opportunity for the caller to record a message, which the network will store and attempt to deliver for a determined period of time. Such services generally attempt to deliver the recorded message over a fixed, predetermined duration (usually 24 hours) after which the attempt is abandoned and the message discarded. The Calling Party cannot typically schedule the time of delivery of the announcement.

The present invention contemplates a new and improved system and method of call delivery that resolves the above-referenced difficulties and others.

### SUMMARY OF THE INVENTION

A system and method for method of call delivery from an Originating End to a Terminating End in a telecommunications network are provided.

In one aspect of the invention a method of call delivery includes generating an Originator-Initiated Direct-To-Call Forwarding Destination (OIDTCFD) indicator for an associated call made by a Calling Party to a Called Party Directory Number, and sending the OIDTCFD indicator from an Originating End to a Terminating End across the telecommunications network notifying the Terminating End that the call is to be sent to the Called Party's Call Forwarding Destination.

In another aspect of the invention, a system of call delivery is provided including means for generating the OIDTCFD indicator for the associated call made by the Calling Party to the Called Party Directory Number, and means for sending the OIDTCFD indicator from an Originating End to a Terminating End across the telecommunications network notifying the Terminating End that the call is to be sent to the Called Party's Call Forwarding Destination.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating the invention;

FIG. 2 is a flow chart illustrating steps of the invention;

FIG. 3 is a flow chart illustrating more steps of the invention;

FIG. 4 is a flow chart illustrating more steps of the invention;

FIG. 5 is a flow chart illustrating more steps of the invention; and

FIG. 6 is a flow chart illustrating more steps of the invention.

### DETAILED DESCRIPTION

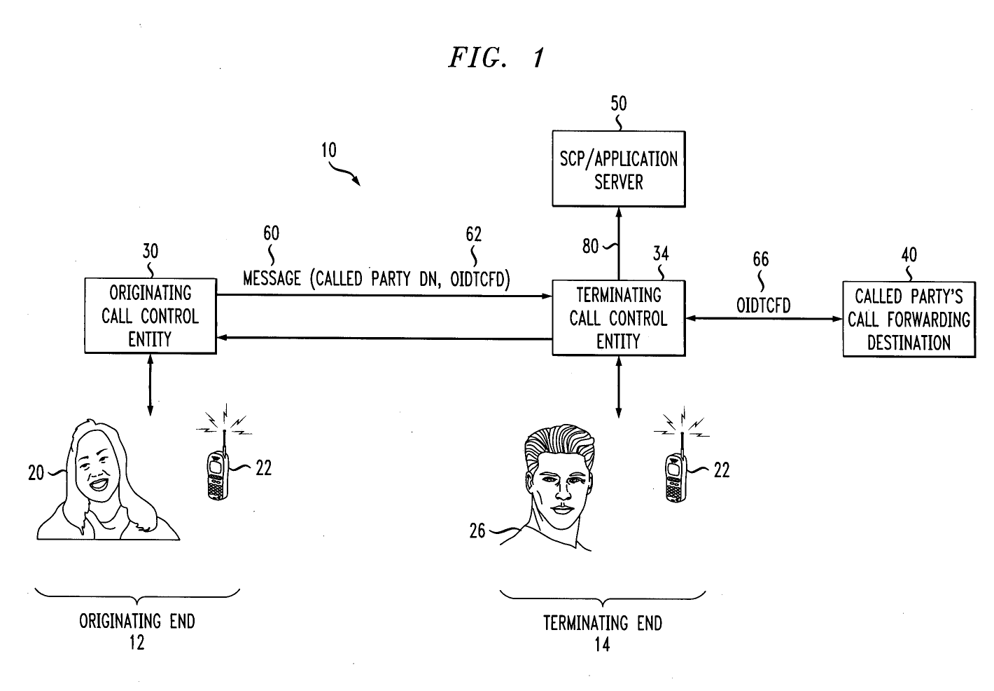

Referring now to the drawings wherein the showings are for purposes of illustrating the exemplary embodiments only and not for purposes of limiting the claimed subject matter, FIG. 1 provides a view of a system into which the presently described embodiments may be incorporated.

As shown generally, FIG. 1 includes a block diagram illustrating a portion of a telecommunications network, shown generally at 10, for providing call delivery across the network from an Originating End 12 to a Terminating End 14. The telecommunications network 10 can be a wireless network, also known as a cellular network, a landline network, an Internet Protocol Multimedia Subsystem (IMS) network, or a Voice over IP network, among others, or suitable combinations thereof.

A Calling Party 20 uses a Calling Party terminal 22, located at the Originating End 12 of the network 10, to place a call to a Called Party Destination 24, located at the Terminating End 14. The Calling Party 20 and Calling Party Terminal 22 are, therefore, defined as Originators, since the call originates therefrom. The Calling Party terminal 22 can be a wireless or cellular terminal, a landline terminal, an IMS terminal, an IP terminal or other device or system capable of making, or originating, the call.

The Called Party Destination 24 can be a wireless or cellular terminal, a landline terminal, an IMS terminal, an IP terminal or other device capable of receiving a call. The Called Party Destination 24 can also be the Called Party's Voice Mail system, or an alternate network-based message recording system different from the Called Party's ordinary Voice Mail system, capable of receiving a call. Calls are typically routed to the Called Party Destination 24 using a Directory Number, also known as a phone number, for that destination. The Directory Number can also be a Universal Resource Locator (URL) for use with IP-based networks.

An Originating Call Control Entity 30 serves the Calling Party Terminal 22 by setting up the call and routing the call towards the Terminating End 14 using call control messaging as shall be described in further detail below. The Originating Call Control Entity 30 is, therefore, also referred to as an Originator, and is disposed at the Originating End 12 of the network 14.

A Terminating Call Control Entity 34 serves the Called Party 26, receiving the call control messaging from the Originating Call Control Entity 30, and setting up and routing the call to the proper Called Party destination 24. The Terminating Call Control Entity 34 is located at the Terminating End 14 of the network 10.

The Terminating Call Control Entity 34 can also route the call to a Called Party's Call Forwarding Destination 40 using a Forward-to Directory Number, as shall be described in further detail below. The Called Party's Call Forwarding Destination 40 can be a Voice Mail system, or other network-based voice recording system, capable of receiving the Calling Party's call routed thereto using a Forward-to Directory Number.

The Originating and/or Terminating Call Control Entities 30, 34 can be 5ESS switches, IMS-compatible systems, UMTS/CDMA/GSM Mobile Switching Centers, or other network nodes suitable for the corresponding network 10.

A Service Control Point (SCP) 50 is connected to the Terminating Call Control Entity 34 for providing services to the Called Party such as call screening, as shall be described in further detail below. The SCP 50 can be an Application Server or other processing node suitable for the corresponding network 10.

The system and method of call delivery described herein includes providing an indicator in call control signaling sent from the Originating End 12 of the network to the Terminating End 14 which indicates that the call is to be call forwarded without ringing the Called Party's Destination 24 as defined by the dialed Called Party Directory Number. This can occur regardless of the status of the dialed Called Party's Destination 24, such as it being busy, or not answered. This can also occur without a conventional Call Forwarding Attendant relationship between the Terminating Call Control Entity 34 and the Called Party 26. The indicator can be considered to be an Originator-initiated indicator, because the Terminating End 14 does not request, or prompt, the Originator to provide the indicator.

The system and method of call delivery described herein is independent of access, network, and signaling technology, and thus could be used with landline, cellular, an Internet Protocol Multimedia Subsystem (IMS), among others, or suitable combinations thereof.

A method for providing Originator Initiated Direct-to-Call Forwarding Destination (OIDTCFD) call delivery shall now be described. In the example provided herein, which should not be considered limiting, a Calling Party 20 calls a Called Party 26, but wants to leave a Voice Mail message for the Called Party rather than speaking to her. Utilizing the invention as described herein, the Calling Party 20 uses the Calling Party Terminal 22 to make an OIDTCFD call which does not ring the Called Party Destination 24 having the Directory Number the Calling Party has just dialed. Instead, the call is forwarded directly to the Called Party's Call Forwarding Destination using a Forward-to Directory Number as described in further detail below. The Calling Party 20 does not need to know the Forward-to Directory Number to reach this Called Forwarding Destination. Further details, features and advantages of the invention shall be described below.

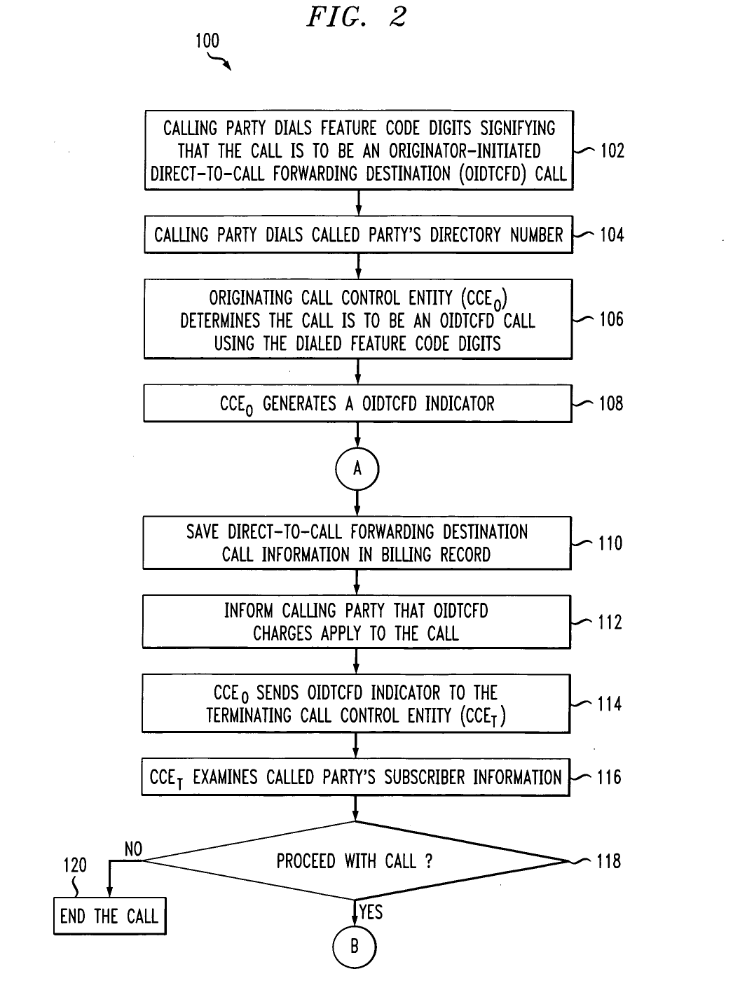

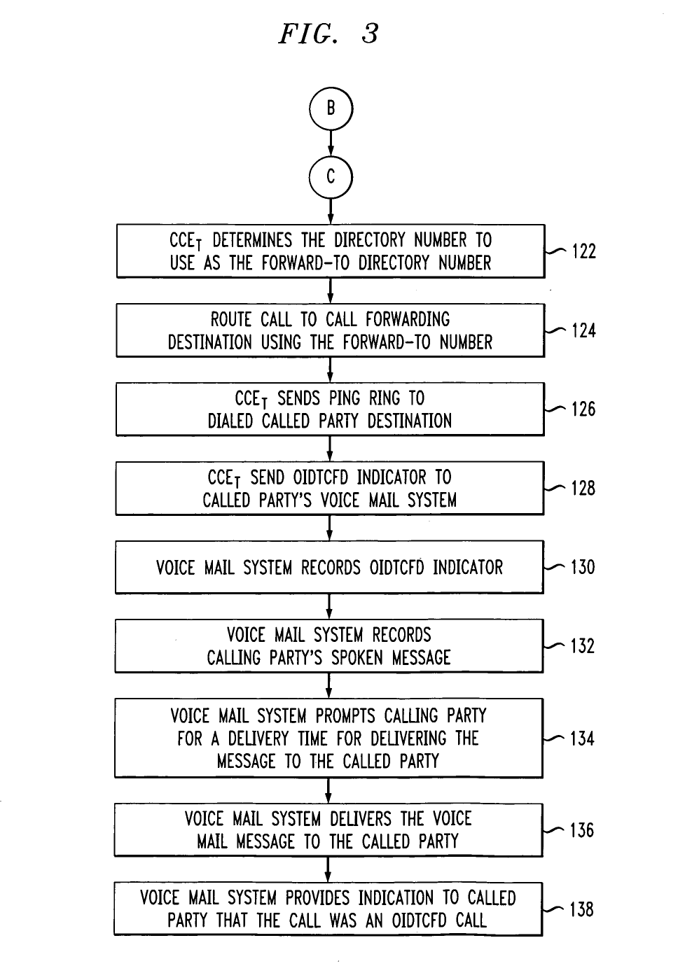

Referring now to FIG. 2, the Calling Party 20 calls the Called Party 26. The Calling Party 20 dials one or more feature code digits signifying that this call is to be an OIDTCFD call at 102 and dials the Called Party's Directory Number at 104. These steps can occur in any order or may be combined. In one example, the Calling Party 20 can accomplish steps 102 and 104 by dialing *## and then dialing the Called Party Directory Number.

The Originating Call Control Entity 30 determines that the call is to be an OIDTCFD call at 106 using logic which recognizes the dialed feature code digits as signifying the associated call is to be an OIDTCFD call.

The Originating Call Control Entity 30 begins to set-up the call for routing the call to the Terminating Call Control Entity 34 serving the Called Party 26 utilizing the Called Party Directory Number that the Calling Party has dialed. During call set-up, the Originating Call Control Entity 30 generates an OIDTCFD indicator at 108. The OIDTCFD indicator can be a special bit, a flag, a command, or other portion of a call control message capable of notifying the Terminating End 14 that the associated call is an OIDTCFD call and is to be handled as described herein.

The Originating Call Control Entity 30 can optionally save information in a billing record at 110 indicating that the Calling Party 20 has made/requested an OIDTCFD call to bill the Calling Party 20 for this service, if so desired. Step 110 can occur later in this call delivery process, such as for example while the call is being delivered to the Call Forwarding Destination or afterwards.

The Originating Call Control Entity 30 can optionally inform the Calling Party that OIDTCFD charges apply to the call at 112.

At step 114, the Originating Call Control Entity 30 sends the OIDTCFD indicator across the telecommunications network to the Terminating Call Control Entity 34 at the Terminating End 14. The OIDTCFD indicator notifies the Terminating Call Control Entity 34 that the call is an OIDTCFD call which is to be sent directly to the Called Party's Call Forwarding Destination 40 without ringing the Called Party Destination 24 as defined by the Directory Number dialed by the Calling Party in step 102.

The Originating Call Control Entity 30 sends the OIDTCFD indicator 60 to the Terminating Call Control Entity 34 in a call control message 62 shown in FIG. 1. The OIDTCFD indicator can be used in any call control signaling protocol that is suitable for the given network in which the call is made, and thus is independent of access, network, and signaling technology.

Some examples, which should not be considered limiting, include the OIDTCFD indicator being sent in a SIP INVITE call control message, or an ISUP Initial Address Message (IAM) message, among others.

The OIDTCFD indicator is Originator-Initiated because no node at the Terminating End 14, such as for example an Attendant or the Terminating Call Control Entity 34, prompts or requests the Originator to provide the OIDTCFD indicator. Rather, the Originator, such as the Originating Call Control Entity 34 or the Calling Party Terminal 22, generates the OIDTCFD indicator and sends it to the Terminating End 14 to notify the Terminating End that the call is to be Forwarded directly to the Called Party's call forwarding destination.

The Terminating Call Control Entity 34 receives the OIDTCFD indicator in the call control messaging and examines the Called Party's subscriber information at 116. The Terminating Call Control Entity 34 can use this information to determine whether to proceed with the call at 118.

For example, a Service Provider can provide this system and method of call delivery only to subscribing parties, if so desired. Alternatively, it can be provided to all parties. If a subscription is required, the Terminating Call Control Entity 34 can determine whether or not the Called Party 26 subscribes to this service using Called Party subscriber information stored in a subscribe database and associated with the Called Party in a known manner. The subscriber database can be stored at the Terminating Call Control Entity 34, on the Called Party's Home Location Register (HLR), or in other suitable locations/nodes in the network 10. If the Called Party 26 does not subscribe, the Terminating Call Control Entity 34 can end the call at 120.

Other conditions, besides the existence of subscription privileges, can be used by the Terminating Call Control Entity 34 in determining whether to proceed with the call at 118. For example, the Called Party can pre-provision a directive to inhibit any OIDTCFD calls made to them. In this example, the Terminating Call Control Entity 34 can obtain this directive from the subscriber information obtained in 116 and will determine at 118 to end the call at 120.

After being notified by the OIDTCFD indicator that the incoming call is to be directly forwarded to the Called Party's Call Forwarding Destination, the Terminating Call Control Entity 34 at 122 determines the appropriate Forward-to Directory Number needed to route the call thereto. The Terminating Call Control Entity 34 can determine the Forward-to Directory Number in a variety of different ways.

The Called Party 26 may provide a specific Forward-to Directory Number for OIDTCFD calls made to the Called Party. The Called Party 26 can pre-provision the network with this Directory Number and it can be stored in the network, such as for example in subscriber database. This Directory Number may by the same as the Forward-to Directory Number of other types, or “flavors”, of Call Forwarding which cause the call to be forwarded to the Called Party's Voicemail System.

If a Forward-to Directory Number specific to the OIDTCFD service has not been provisioned by, or for, the specific Called Party 26, the Terminating Call Control Entity 34 may be provisioned with global settings to use the Forward-to Directory Number of a particular type of Call Forwarding Destination. For example, the Forward-to Directory Number typically used for Call Forwarding when the Called Party Destination 24 does not answer can also be used for OIDTCFD calls. Alternatively, the global setting may dictate that the Terminating Call Control Entity 34 use the same Forward-to Directory number for all OIDTCFD calls made to all subscribers to send all such calls to the same Voice Mail system destination number.

The Terminating Call Control Entity 34 then routes the call at 124 to the Called Party's Call Forwarding Destination 40 using the Forward-to Directory Number determined in step 122. For example, the Forward-to Directory Number for the Called Party's Voice Mail system is used to forward the call thereto. The Terminating Call Control Entity 34 did not ring the Called Party Destination 24 defined by the Directory Number dialed by the Calling Party in step 102 above, and thus did not determine the availability of the Called Party destination.

However, the Terminating Call Control Entity 34 can provide an optional indication to the Called Party Destination 24 at 126 that the Called Party has/is receiving an OIDTCFD call. This can occur either before, during or after the Calling Party is leaving/has left the recorded voice message at the Call Forwarding Destination as described below. Examples of providing such an indication can include the Terminating Call Control Entity 34 providing a ping ring to the Called Party Destination 24. The ping ring provides an audible indication to the Called Party phone 24 that someone is trying to reach the Called Party such as by an OIDTCFD call. A bearer path capable of providing voice communications is not established, or attempted to be established, to the Called Party phone 24 during a ping ring, as would happen when the ringing the Called Party Destination. Other examples can include, but are not limited to, the Terminating Call Control Entity 34 sending such an indication via call control messaging, or via other forms of messaging to light an indicator light on the Called Party Destination phone 24 or enabling the phone to give such an indication via a symbol displayed on the screen, or sending a text message to the phone 24.

At step 128, the Terminating Call Control Entity 34 can also send the OIDTCFD indicator to the Called Party's Voice Mail system 40 in the forwarded call leg in a manner in which it can be associated with the call, such as for example via call control messaging as indicated at 66 in FIG. 1. By receiving the OIDTCFD in this manner, the Voice Mail system 40 can recognize the call as being an OIDTCFD call, thereby distinguishing it from other calls including calls forwarded in a conventional manner. The Voice Mail system 40 can record the OIDTCFD indicator at 130, if so desired.

The Voice Mail system 40 records the spoken message from the Calling Party 20 at 132 to generate a Voice Mail message for the Called Party 26.

Additionally, if so desired, the Voice Mail system 40 can prompt the Calling Party 20 for a delivery time for this Voice Mail message at 134. The Calling Party 20 can indicate the time she would like to have the Voice Mail message delivered to the Called Party 26, such as, for example, the time at which the Called Party is alerted to having received the Voice Mail message. The Voice Mail System delivers the Voice Mail message to the Called Party at 136.

The Voice Mail system 40 can notify the Called Party 26 at 138 that the Calling Party 20 has left a Direct-to-Call Forwarding Destination Voice Mail message without ringing the Called Party's phone using the OIDTCFD indicator saved in step 130.

Referring now to FIG. 4, an example is shown generally at 200 in which the Calling Party Terminal 22 generates the OIDTCFD indicator for the associated call. The Calling Party 20 dials the called Party's Directory Number at 202. The Calling Party 20 uses a Calling Party terminal 22 capable of generating the OIDTCFD indicator in the call control messaging at 204. Call Setup then begins as the Originating Call Control Entity 30 receives the OIDTCFD indicator and Called Party Directory Number at 206. Call delivery of the OIDTCFD call then proceeds from step 110 as described above. The Originating Call Control Entity 30 may generate/use a different OIDTCFD indicator than it receives from the Calling Party Terminal 22 depending on the protocols used.

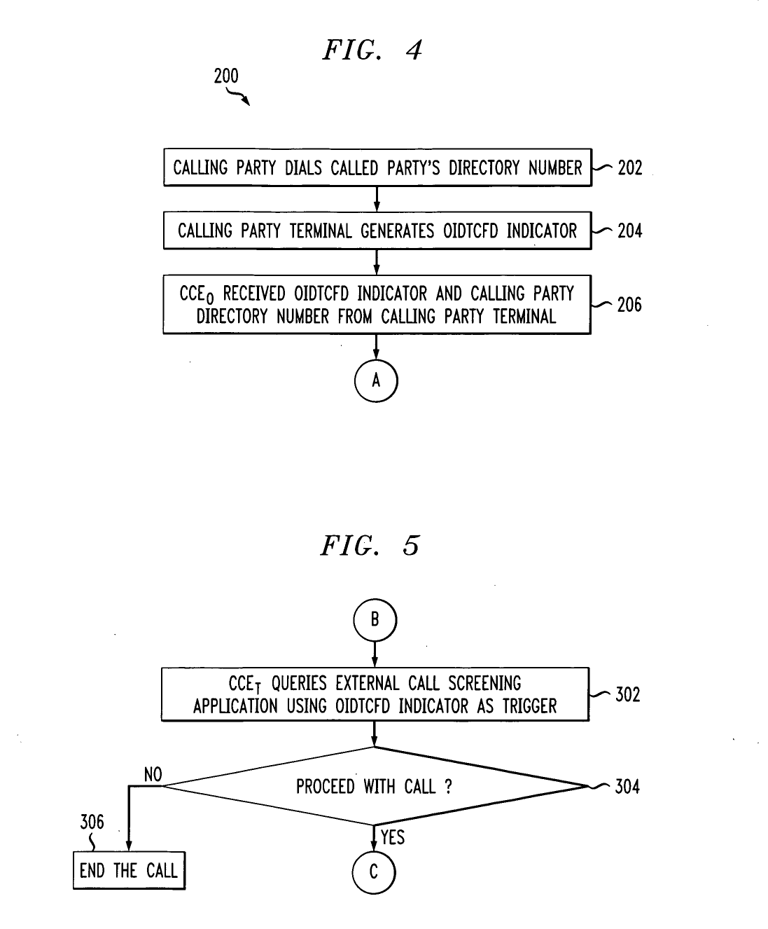

Referring now to FIG. 5, an example is shown in which the Called Party 26 has a Call Screening Service. Programming logic is provided at the Terminating Call Control Entity 34 and the SCP 50 to create a new OIDTCFD trigger detection point for Call Screening. The Terminating Call Control Entity 34 uses the receipt of the OIDTCFD indicator as a trigger to initiate a query to the external Service Control Point (or Application Server) 50 at 302 to determine if the call should proceed in accordance with pre-provisioned Call Screening parameters at 304. This query can be a new OIDTCFD query 80 as shown in FIG. 1, or a new parameter in an existing query message can be used. The query can contain an OIDTCFD indicator which can be associated with the call, such as for example by also including the Calling Party Number and Called Party Number, or in other suitable manners. The OIDTCFD indicator may be different than the OIDTCFD indicator sent from the Originating End, depending on the protocols used.

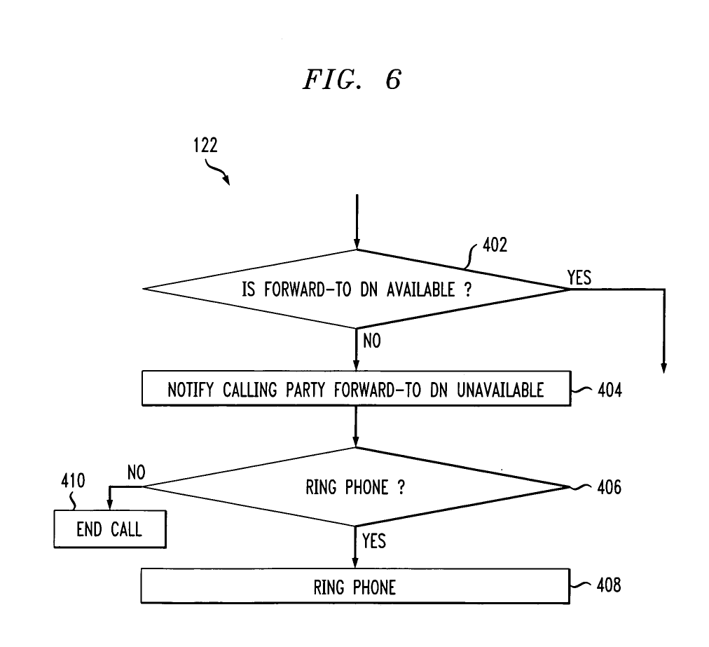

Referring now to FIG. 6, step 122 described above, in which the Terminating Call Control Entity 34 determines the Forward-To Directory Number, shall be described in further detail. The Terminating Call Control Entity 34 determines if a Forward-to Directory Number is available at 402. The Called Party 26 may not have a Forward-to Directory Number available for a variety of reasons, including not having Call Forwarding service, and choosing not to use any Call Forwarding Destinations for OIDTCFD calls, among others. If it is determined that no Forward-To Directory Number is available, the Terminating Call Control Entity 34 notifies the Calling Party that the Forward-to Directory Number is unavailable at 404. The Terminating Call Control Entity 34 can then prompt the Calling Party 20 to determine, at 406, if the Calling Party would like to ring the phone 24 instead. If the Calling Party 20 would like the call to be placed to the Called Party's phone 24 as defined by the Called Party Directory Number dialed in step 104 above, the Terminating Call Control Entity 34 can proceed with routing the call thereto. Alternatively, if the Calling Party 20 does not want to ring the Called Party's phone, the call can be ended at 410.

The system and method of call delivery described herein enables the Calling Party, rather than the Attendant/Call-Taker on the Terminating End 14, to direct the call to the Called Party's Voice Mail system as defined by the suitable Forward-to Directory Number. It does not require the Calling and Called Parties to be served by the same switch, and it does not require any type of relationship (e.g. coverage service) between the Calling Party 20 and the Called Party 26. Also, the Called Party Directory Number dialed by the Calling Party is not rung, though a “ping ring” may optionally be used.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of call delivery from an Originating End to a Terminating End in a telecommunications network comprising:
generating an Originator-Initiated Direct-To-Call Forwarding Destination (OIDTCFD) indicator for an associated call made by a Calling Party to a Called Party Directory Number; and
sending the OIDTCFD indicator from an Originating End to a Terminating End across the telecommunications network notifying the Terminating End that the call is to be sent to the Called Party's Call Forwarding Destination.

2. The method defined in claim 1 wherein the Called Party's Call Forwarding Destination is a voice message recording system.

3. The method defined in claim 2 wherein the voice message recording system is the Called Party's Voice Mail system.

4. The method defined in claim 1 wherein the generating step further comprises:
generating the OIDTCFD indicator at the Calling Party Terminal.

5. The method defined in claim 1 wherein the generating step further comprises:
generating the OIDTCFD indicator at an Originating Call Control Entity servicing the Calling Party Terminal.

6. The method defined in claim 1 wherein the sending step further comprises:
sending the OIDTCFD indicator in a call control message.

7. The method defined in claim 6 wherein the call control message is an ISUP Initial Address Message (IAM) message or a Session Initiation Protocol (SIP) INVITE message.

8. The method defined in claim 1 wherein the sending step occurs during call set-up for the associated call.

9. The method defined in claim 1 further comprising:
receiving the OIDTCFD indicator at a Terminating Call Control Entity serving the Called Party at the Terminating End;
the Terminating Call Control Entity determining a Forward-to Directory Number for the Called Party; and
the Terminating Call Control Entity forwarding the call to the Called Party's Call Forwarding Destination using the Forward-to Directory Number.

10. The method defined in claim 9 wherein the Forward-to Directory Number is one of a Call Forwarding Direct Directory Number, a Call Forwarding if Busy Directory Number, and a Call Forwarding if No Answer Directory Number.

11. The method defined in claim 10 further comprising:
the Called Party specifying the type of Forward-to Directory Number to be used by the Terminating Call Control Entity upon receiving the OIDTCFD indicator.

12. The method defined in claim 9 wherein the Called Party provides a OIDTCFD Forward-to Directory Number to be used for all OIDTCFD calls.

13. The method defined in claim 9 wherein the Terminating Call Control Entity has a global setting for determining the Forward-to Number for OIDTCFD calls.

14. The method defined in claim 13 wherein the global setting includes choosing the same type of Forward-to Number for all OIDTCFD calls.

15. The method defined in claim 13 wherein the global setting includes choosing the same Forward-to Number for all OIDTCFD calls.

16. The method defined in claim 9 further comprising:
the Terminating Call Control Entity sending the OIDTCFD indicator to the Called Party's Call Forwarding Destination.

17. The method defined in claim 16 wherein the OIDTCFD indicator is sent to the Called Party's Call Forwarding Destination in call control messaging.

18. The method defined in claim 16 wherein the Called Party's Call Forwarding Destination is the Called Party's Voice Mail system and further comprising:
the Voice Mail system recording a voice message from the Calling Party.

19. The method defined in claim 18 further comprising:
the Called Party's Voice Mail system prompting the Calling Party for a time of delivery for when the voice message is to be delivered to the Called Party.

20. The method defined in claim 19 further comprising the Called Party's Voice Mail system delivering the voice message to the Called Party at a time provided by the Calling Party.

21. The method defined in claim 16 further comprising:
providing the Called Party with an indication that the Calling Party made an OIDTCFD call.

22. The method defined in claim 1 wherein the Called Party has a Call Screening service and further comprising:
the Terminating Call Control Entity using the receipt of the OIDTCFD indicator as a trigger to send a query to the Call Screening service for determining if the call should proceed, the query including the OIDTCFD indicator.

23. The method defined in claim 1 further comprising:
recording the OIDTCFD indicator for billing purposes.

24. The method defined in claim 23 wherein the recording step further comprises recording the OIDTCFD indicator at at least one of the Originating End and the Terminating End.

25. The method defined in claim 1 further comprising;
providing an indication to the Called Party Destination dialed by the Calling Party for alerting the Called Party of the receipt of an OIDTCFD call.

26. The method defined in claim 1 further comprising;
enabling the Called Party to prevent the Calling Party from making an OIDTCFD call to the Called Party.

27. A system for providing call delivery from an Originating End to a Terminating End in a telecommunications network comprising:
means for generating an Originator-initiated Direct-To-Call Forwarding Destination (OIDTCFD) indicator for an associated call made by a Calling Party to a Called Party Directory Number; and
an Originating Call Control Entity disposed at a Originating End of the telecommunications network for sending the OIDTCFD indicator from the Originating End to a Terminating End across the telecommunications network notifying the Terminating End that the call is to be sent directly to the Called Party's Call Forwarding Destination.

28. The system defined in claim 27 wherein the means for generating the OIDTCFD indicator comprises the Calling Party Terminal.

29. The system defined in claim 27 wherein the means for generating the OIDTCFD indicator comprises an Originating Call Control Entity servicing a Calling Party Terminal.

30. The system defined in claim 27 wherein the Originating Call Control Entity sends the OIDTCFD indicator to the Terminating End in a call setup message.

31. The system defined in claim 27 wherein the call control message is an ISUP Initial Address Message (IAM) message or a Session Initiation Protocol (SIP) INVITE message.

32. The system defined in claim 27 further comprising:
a Terminating Call Control Entity serving the Called party and disposed at the Terminating End, the Terminating Call Control Entity connected to the Originating Call Control Entity via the telecommunications network for receiving the OIDTCFD indicator therefrom;
the Terminating Call Control Entity determining a Forward-to Directory Number for the Called Party; and
the Terminating Call Control Entity forwarding the call to the Called Party's Call Forwarding Destination using the Forward-to Directory Number.

33. The system defined in claim 32 wherein the Called Party's Call Forwarding Destination is the Called Party's Voice Mail system which records a voice message from the Calling Party.

34. The system defined in claim 33 wherein the Terminating Call Control Entity sends the OIDTCFD indicator to the Called Party's Voice Mail system.

35. The system defined in claim 34 further comprising:
the Called Party's Voice Mail system prompting the Calling Party for a time of delivery for when the voice message is to be delivered to the Called Party and delivering the voice message to the Called Party at that time.

36. The system defined in claim 34 wherein the Called Party's Voice Mail system provides the Called Party with an indication that the Calling Party made an OIDTCFD call.

37. The system defined in claim 27 further comprising:
a Call Screening service provided by a network node separate from the Terminating Call Control Entity, wherein the Terminating Call Control Entity uses the receipt of the OIDTCFD indicator as a trigger to send a query to the Call Screening service for determining if the call should proceed, the query including the OIDTCFD indicator.

38. The system defined in claim 27 further comprising:
means for recording the OIDTCFD indicator for billing purposes disposed at at least one of the Originating End and the Terminating End.

39. The system defined in claim 27 further comprising;
means for providing an indication to the Called Party Destination dialed by the Calling Party for alerting the Called Party of the receipt of an OIDTCFD call.

40. The system defined in claim 27 further comprising;
means for enabling the Called Party to prevent the Calling Party from making an OIDTCFD call to the Called Party.
